(19) United States
(12) Patent Application Publication
(10) Pub. No.: US 2014/0034017 A1
(43) Pub. Date: Feb. 6, 2014

(54) ADJUSTMENT DEVICE OF HIGH-PRESSURE PUMP

(71) Applicant: Kazuhiro Omae, Atsugi-shi (JP)

(72) Inventor: Kazuhiro Omae, Atsugi-shi (JP)

(21) Appl. No.: 13/511,756

(22) PCT Filed: Apr. 27, 2011
(86) PCT No.: PCT/JP11/60224

§ 371 Date: May 24, 2012

(51) Int. Cl. F02M 39/02

(52) U.S. Cl. CPC F02M 39/02
USPC 123/456; 123/457

(57) ABSTRACT

In an adjustment device of a high-pressure pump for increasing a pressure of a fuel supplied from a feed pump and pressure-feeding the fuel, the adjustment device includes: an inlet valve changing a communication state between a cylinder provided in the high-pressure pump and a feed pump communication path through which the fuel supplied by the feed pump flows, and adjusting an injection amount of the high-pressure pump; a spring member biasing the inlet valve to a closing side; a closing portion, operated by energization, for allowing the inlet valve to move in a closing direction; and a compression amount adjustment member changing a compression amount of the spring member depending on a feed pressure of the feed pump.

### TECHNICAL FIELD

The present invention relates to an adjustment device of a high-pressure pump.

### BACKGROUND ART

Conventionally, there is known a fuel injection system having plural pressure feeding systems made by plural plungers provided in a fuel pump. For example, this is disclosed in Patent Document 1. The fuel injection system disclosed in Patent Document 1 can maintain the controllability of the fuel pressure, even when one of the pressure-feeding system is abnormal. Specifically, when one of the fuel pressure-feeding systems respectively having two plungers is determined abnormal, a pressure-feeding start angle of the fuel pump is forcibly changed to increase the pressure-feeding amount in the normal feeding system.

### PRIOR ART DOCUMENT

### Patent Document

[Patent Document 1] Japanese Patent Application Publication No. 2007-255400

### SUMMARY OF THE INVENTION

### Problems to be Solved by the Invention

Incidentally, there has been known a high-pressure pump equipped with a single plunger in these days. When a failure occurs in an adjustment valve of the high-pressure pump equipped with the single plunger mentioned above, the fuel cannot be pressure-fed from another plunger as described in Patent Document 1. Thus, it is difficult to maintain and continue the fuel injection.

Thus, an adjustment device of a high-pressure pump disclosed herein maintains and continues injection of fuel when a failure occurs in an adjustment valve.

### Means for Solving the Problems

In order to solve the above problem, an adjustment device of a high-pressure pump for increasing a pressure of a fuel supplied from a feed pump and pressure-feeding the fuel, the adjustment device described herein includes: an inlet valve changing a communication state between a cylinder provided in the high-pressure pump and a feed pump communication path through which the fuel supplied by the feed pump flows, and adjusting an injection amount of the high-pressure pump; a spring member biasing the inlet valve to a closing side; a closing portion, operated by energization, for allowing the inlet valve to move in a closing direction; and a compression amount adjustment member changing a compression amount of the spring member depending on a feed pressure of the feed pump.

When the closing portion brings the inlet valve into a closed state in accordance with the biasing force of the spring member, the high-pressure pump can pressure-feed the fuel within a cylinder. Thus, when an abnormality occurs in this closing portion and then the inlet valve cannot close, the pressure-feeding of the fuel may not continue. The inlet valve is biased and moved in a closing direction by the spring member which is installed in a compressed state. Accordingly, an increase in the compression amount of the spring member facilitates the closing of the inlet valve. The compression amount adjustment member changes the compression of the spring member based on the feeding pressure, thereby adjusting the facilitation of opening and closing of the inlet valve.

The compression amount adjustment member may be a plate member including a first surface and a second surface as a rear surface of the first surface. The plate member may hold the spring member is held between the first surface and an engagement flange portion provided in the inlet valve, and a pressure receiving area of the feed pressure on the first surface may be larger than that of the feed pressure on the second surface.

The difference between the areas of the feed pressure receiving surfaces of the first surface and the second surface is provided, thereby changing the compression amount of the spring member based on the feed pressure. Specifically, when the feed pressure decreases, a reduction amount of the force applied to the first surface side having the large pressure receiving area is larger a reduction amount of the force applied to the second surface side having the small pressure receiving area. Accordingly, the force pushing the second surface power is large to move the plate member to the first surface side. This increases the compression amount of the spring member supported at the first surface side. Therefore, the preload of the spring member tends to increase to facilitate the movement of the inlet valve in the closing direction. When the plunger operates in this state, the inlet valve is pushed and closed by the fuel compressed in the cylinder, a so-called self-closing phenomenon occurs. The inlet valve is closed by the self-closing, whereby the high-pressure pump maintains and continues the pressure feeding of the fuel.

The adjustment device of the high-pressure pump may include: a failure determination portion of the closing portion, in a case where the feed pump is electrically operated; and a control portion reducing the feed pressure of the feed pump, when the failure determination portion determines that a failure occurs in the closing portion.

The compression amount adjustment member changes the compression amount of the spring member based on the feed pressure. Specifically, a reduction in the feed pressure increases the compression amount of the spring member. Thus, when a failure is detected in the closing portion, the feed pressure is decreased forcibly. Therefore, the compression amount of the spring member is increased to promote the self-closing phenomenon of the inlet valve, and the injection of the fuel is maintained and continued.

The failure determination portion may determine that a failure occurs in the closing portion depending on a rail pressure of a common rail to which the fuel is supplied from the high-pressure pump. It is possible to use the rail pressure sensor conventionally provided without adding another part.

### Effects of the Invention

An adjustment device of a high-pressure pump disclosed herein can maintain and continue injection of fuel when a failure occurs in an adjustment valve.

### BRIEF DESCRIPTION OF THE DRAWINGS

FIG. 1 is an explanatory view of a general configuration of an adjustment device incorporated into a high-pressure pump according to an embodiment;

FIG. 2A is a plane view of a plate member incorporated into the adjustment device, FIG. 2B is a bottom view, and FIG. 2C is a sectional view taken along line A-A;

FIG. 3A is an explanatory view of a state where an inlet valve opens in a normal state of the adjustment device, and FIG. 3B is an explanatory view of a state where the inlet valve closes in the normal state of the adjustment device;

FIGS. 4A to 4D are explanatory views of states where the high-pressure pump injects the fuel in the normal state;

FIG. 5A is an explanatory view of a state where the inlet valve opens in a solenoid failure state of the adjustment device, and FIG. 5B is an explanatory view of a state where the inlet valve closes in the solenoid failure state of the adjustment device;

FIGS. 6A to 6D are explanatory views of states where the high-pressure pump injects the fuel in the solenoid failure state; and

FIG. 7 is a graph illustrating a relationship between a feed pressure of a feed pump and an engine rotational number.

### MODES FOR CARRYING OUT THE INVENTION

The embodiment according to the present invention will be described below with reference to the accompanying drawings. Herein, a ratio and a dimension of each component illustrated in the drawings may not correspond to the actual ones. Also, in some cases, details may be omitted in the drawings.

### Embodiment

An adjustment device 20 of a high-pressure pump (hereinafter, referred to as “adjustment device) according to the embodiment is installed in a high-pressure pump 100. The adjustment device 20 is an injection amount adjustment valve (PCV: Control Valve). The high-pressure pump 100 compresses and pressure-feeds the fuel supplied from the electric feed pump 1. The high-pressure pump 100 includes a plunger 102 slidably arranged within a cylinder 101. The high-pressure pump 100 is the single pipe pump including the single cylinder 101 and the single plunger 102. The adjustment device 20 is provided between the feed pump 1 and the high-pressure pump 100. The adjustment device 20 includes an inlet valve 3 which changes a communication state between the cylinder 101 provided in the high-pressure pump 100 and a feed pump communication path 2 through which the fuel supplied by the feed pump 1 flows, and which adjusts an injection amount of the high-pressure pump 100. The inlet valve 3 is arranged such that its end formed with a taper-shaped seat surface 3a is located within the cylinder 101. That is, the inlet valve 3 is arranged to penetrate through an inlet hole 101a formed at an upper portion of the cylinder 101. The seat surface 3a of the inlet valve 3 seats a taper-shaped seat portion 101a1 formed around the inlet hole 101a, and then the cylinder 101 is brought into be a closed state. The plunger 102 is upward and downward moved by a cam 103, whereby the high-pressure pump 100 pressure-feeds the fuel to a common rail 14. When the fuel supplied from the feed pump 1 is introduced into the cylinder 101, the inlet valve 3 is brought into an opened state. Further, a closing degree of the inlet valve 3 is adjusted when the fuel is ejected by the plunger 102, thereby controlling the injection amount. Additionally, a check valve 15 is provided between the high-pressure pump 100 and the common rail 14.

The inlet valve 3 is slidably supported by a body portion 4. The body portion 4 includes an atmosphere releasing path 4a. The body portion 4 is provided with a pipe-shaped portion 5. A gasket 6 is provided between the body portion 4 and the pipe-shaped portion 5 to separate the inside of the pipe-shaped portion 5 from the atmosphere releasing path 4a. The feed pump communication path 2 communicates with the inside of the pipe-shaped portion 5 to which a feed pressure is applied.

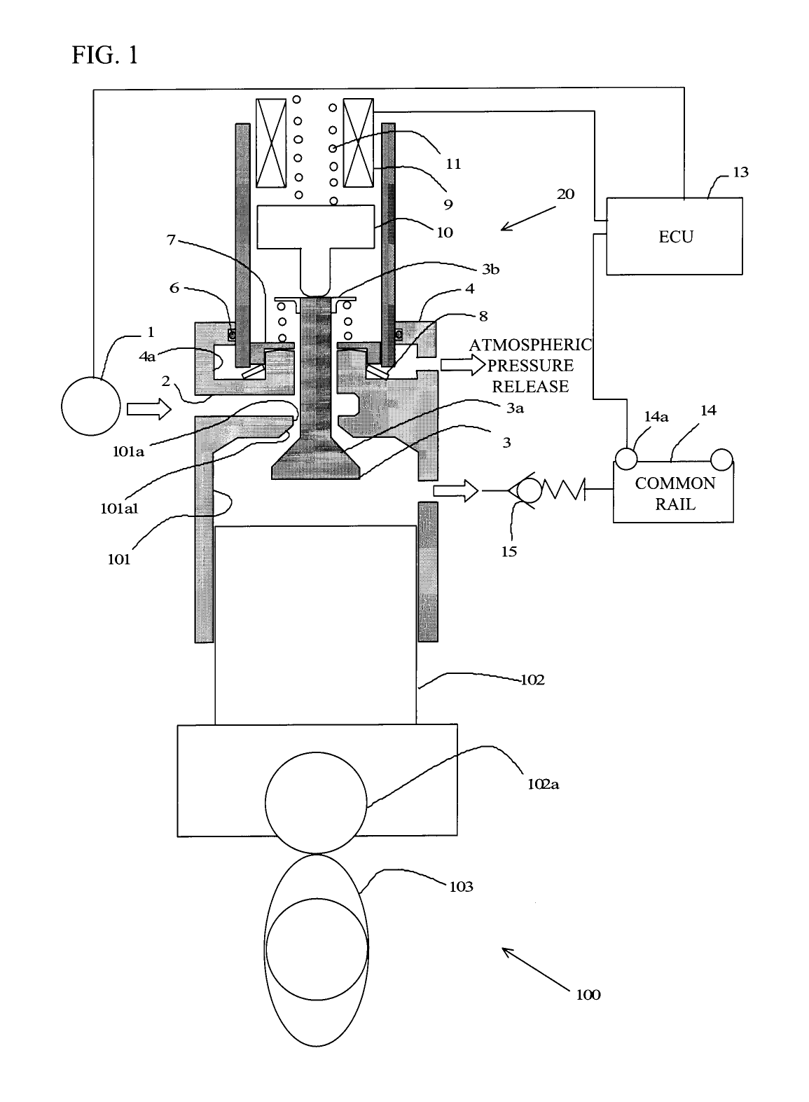

The adjustment device 20 includes a spring member 12 for biasing the inlet valve 3 to a closing side, that is, in an upper direction in FIG. 1. Also, the adjustment device 20 includes a closing portion, operated by energization, for allowing the inlet valve 3 to move in the closing direction. The closing portion includes a solenoid 9 and an armature 10. The solenoid 9 and the armature 10 are arranged within the pipe-shaped portion 5. When the solenoid 9 is not energized, the armature 10 abuts with the inlet valve 3, and a spring member 11 biases the inlet valve 3 to the opening side, thereby opening the inlet valve 3. When the solenoid 9 is energized, the armature 10 is attracted to the solenoid 9 side while the armature 10 compresses the spring member 11. Therefore, the inlet valve 3 biased to the closing side by the spring member 12 is moved.

The inlet valve 3 is provided at its rear end side, that is, at its side where the armature 10 abuts, with an engagement flange portion 3b. The spring member 12 is held between the engagement flange portion 3b and a first surface 7a of a plate member 7. The plate member 7 is an example of a compression amount adjustment member changing a compression amount of the spring member 12 based on the feed pressure of the feed pump.

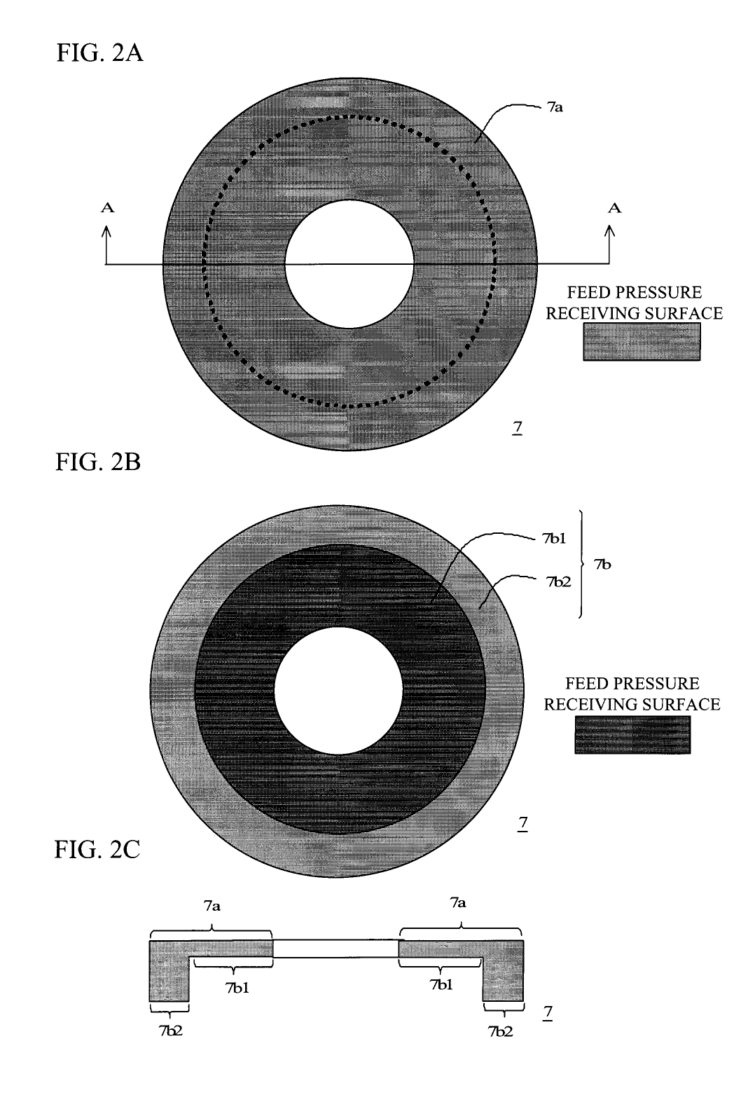

The plate member 7 has a ring shape including the first surface 7a and a second surface as a rear surface of the first surface 7a as illustrated in FIGS. 2A to 2C. As illustrated in FIG. 1, the plate member 7 is arranged such that the first surface 7a is located within the pipe-shaped portion 5. Since the inside of the pipe-shaped portion 5 receives the feed pressure as mentioned above, the entire first surface 7a is a feed pressure receiving surface. On the other hand, a second surface 7b is provided at its edge with a wall portion to partition the second surface 7b into a feed pressure receiving surface 7b1 and an atmospheric pressure receiving surface 7b2. The plate member 7 is mounted on the body portion 4 so as to expose the atmospheric pressure receiving surface 7b2 to the atmosphere releasing path 4a. A disc spring 8 is provided between the atmospheric pressure receiving surface 7b2 and the atmosphere releasing path 4a. The plate member 7 is supported by the body portion 4 through the disc spring 8.

A feed pressure receiving surface area of the first surface 7a, that is, the area of the first surface 7a is larger than a feed pressure receiving surface area of the second surface 7b, that is, the area of the feed pressure receiving surface 7b 1. In such a way, the areas of the feed pressure receiving surfaces are differentiated, thereby changing the position of the plate member depending on a change in the feed pressure. Specifically, the plate member 7 downward moves within the pipe-shaped portion 5 as the feed pressure is higher, whereas the plate member 7 upward moves within the pipe-shaped portion 5 as the feed pressure is lower. The plate member 7 holds the spring member 12 between the first surface 7a and the engagement flange portion 3b. Thus, the plate member 7 upward moves to compress the spring member 12. Since the position of the plate member 7 can be changed depending on the feed pressure, the compression amount of the spring member 12 can be changed depending on the feed pressure. Specifically, a reduction in the feed pressure moves the plate member 7 upward to compress the spring member 12. Thus, the preload increases to facilitate closing the inlet valve 3.

The adjustment device 20 includes an electronic control unit (ECU) 13 as a control portion. The ECU 13 is electrically connected to a rail pressure sensor 14a installed in the common rail 14, the solenoid 9, and the feed pump 1.

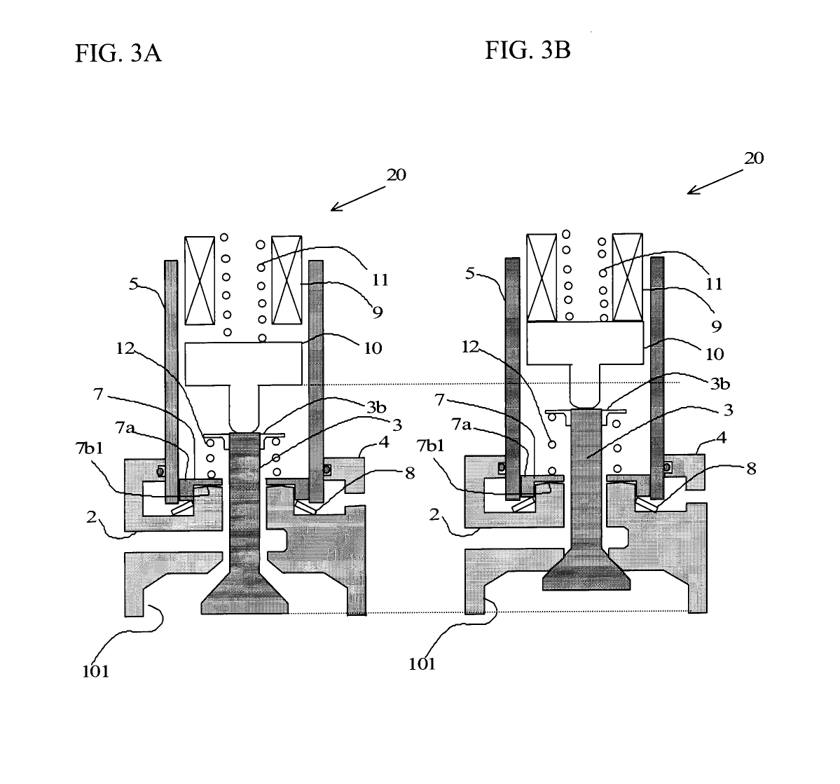

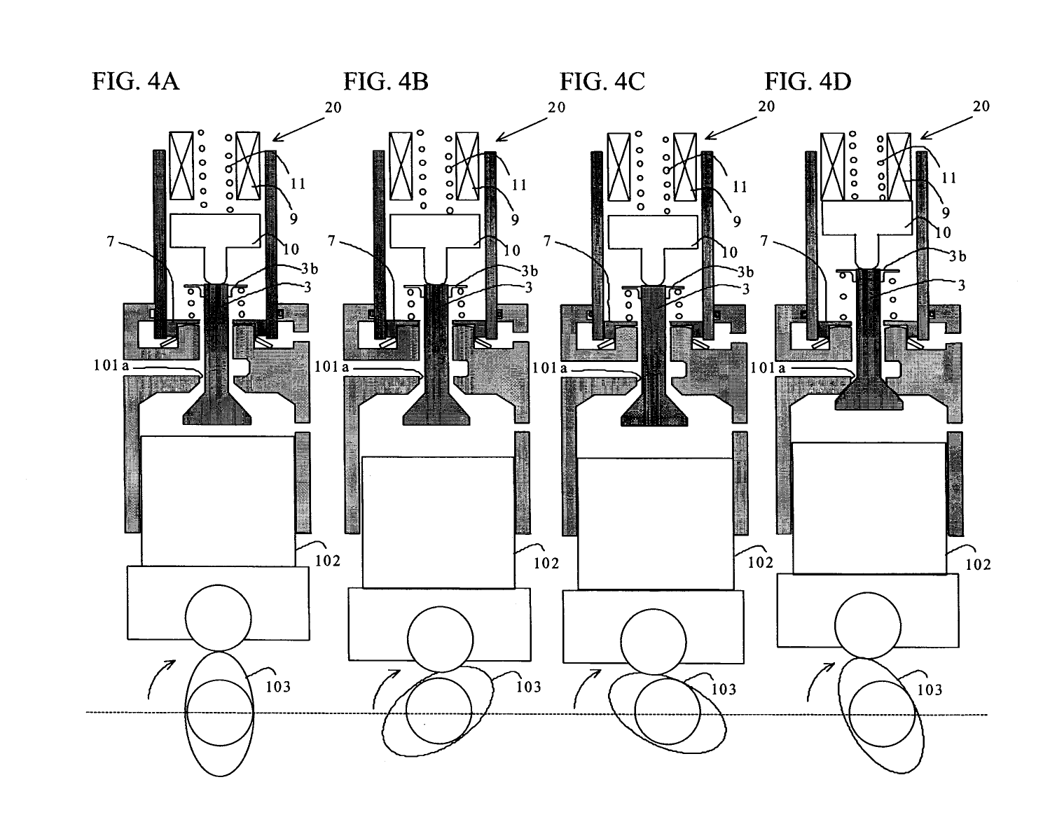

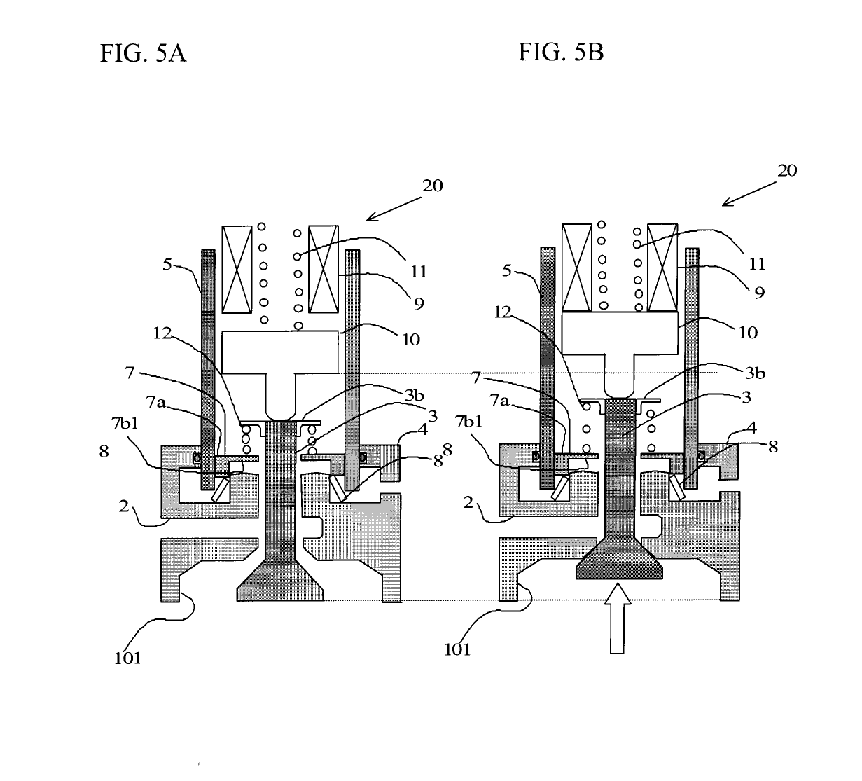

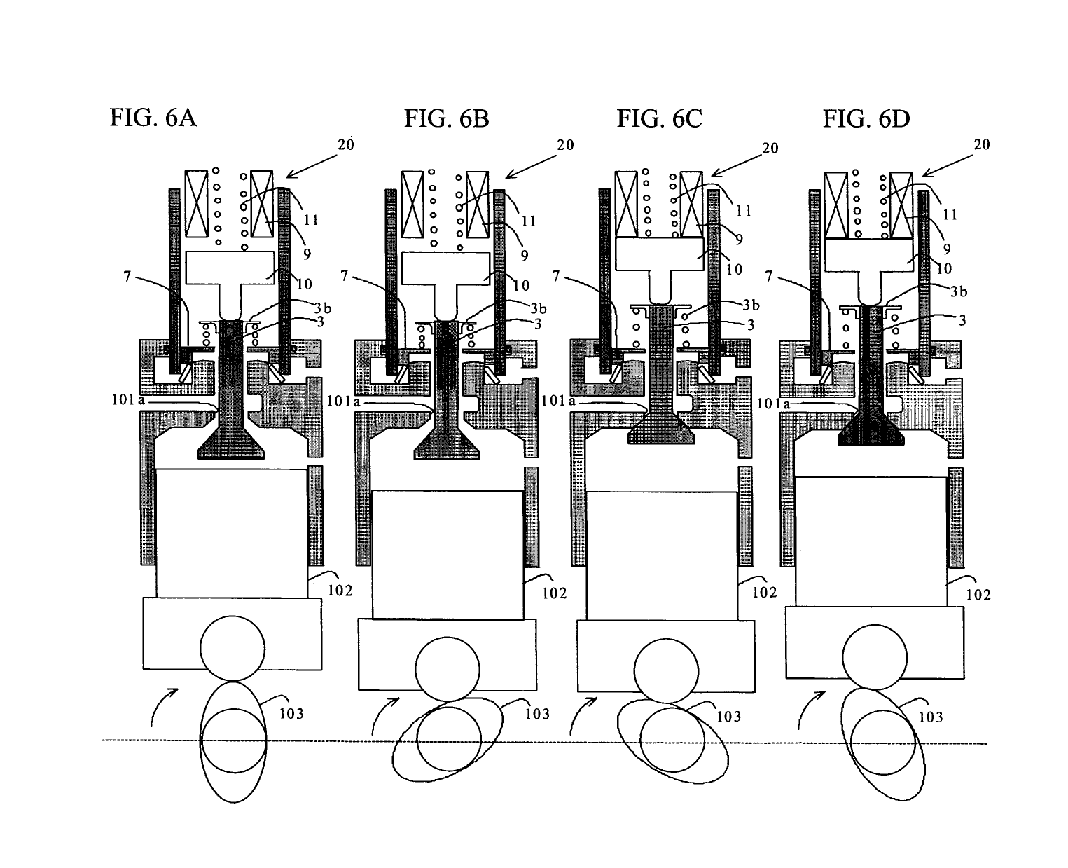

The operation of the above mentioned adjustment device 20 will be described with reference to FIGS. 3 to 6. FIG. 3A is an explanatory view of a state where the inlet valve 3 opens in a normal state of the adjustment device 20, and FIG. 3B is an explanatory view of a state where the inlet valve 3 closes in the normal state of the adjustment device 20. FIGS. 4A to 4D are explanatory views of states where the high-pressure pump 100 injects the fuel in the normal state. FIG. 5A is an explanatory view of a state where the inlet valve 3 opens in a solenoid failure state of the adjustment device 20, and FIG. 5B is an explanatory view of a state where the inlet valve 3 closes in the solenoid failure state of the adjustment device 20. FIGS. 6A to 6D are explanatory views of states where the high-pressure pump 100 injects the fuel in the solenoid failure state.

Firstly, referring to FIGS. 3A and 3B, the first surface 7a of the plate member 7 receives a high feed pressure in a normal state. Thus, the plate member 7 pushes the disc spring 8 downward, and then the pipe-shaped portion 5 is located at the lowest position. The inlet valve 3 is biased by the spring member 11 through the armature 10 so as to be brought into the opened state, when the solenoid 9 is not energized in the normal state as illustrated in FIG. 3A. Further, the armature 10 is attracted to the solenoid 9, when the solenoid 9 is energized as shown in FIG. 3B. Thus, the inlet valve 3 biased by the spring member 12 is brought into the closed state. Additionally, the energization control of the solenoid 9 adjusts the opening degree of the inlet valve 3 to adjust the injection amount of the high-pressure pump 100. The state of the fuel injection will be described in detail. The cam 103 starts rotating with the inlet valve 3 in the opened state as illustrated in FIG. 4A. When the plunger 102 starts moving downward as illustrated in FIG. 4B, the fuel supplied from the feed pump 1 is introduced into the cylinder 101. Next, the plunger 102 starts moving upward to compress the fuel as illustrated in FIG. 4C. At this time, the opened state of the inlet valve 3 continues, and then the fuel within the cylinder 101 is discharged through the inlet hole 101a again. The injection amount is adjusted by adjusting the discharging amount. After a given amount of the fuel is introduced through the inlet hole 101a so as to eject a desired amount of the fuel, the solenoid 9 is energized to close the inlet valve 3 as illustrated in FIG. 4D. The inlet valve 3 is brought into the closed state, whereby the fuel compressed, by the plunger 102, within the cylinder 101 is fed to the common rail 14 side.

Next, referring to FIGS. 5A and 5B, the first surface 7a of the plate member 7 receives the feed pressure lower than that in the normal state. That is, the feed pump 1 is controlled based on the instruction of the ECU 13, and the suppressed feed pressure is applied. When the ECU functioning as a failure determination portion detects a reduction in a value from the rail pressure sensor 14a, the ECU determines that it is caused by a failure in the solenoid 9. The feed pump 1 is controlled to reduce the feed pressure. For this reason, the pressure received by the first surface 7a of the plate member 7 is lower relatively. The plate member 7 moves upward within the pipe-shaped portion 5 depending on the repulsive force of the disc spring 8 and the balance between forces respectively applied to the first surface 7a and the second surface 7b. The plate member 7 moves upward to increase the compression amount of the spring member 12. This results in an increase in the preload of the spring member 12, whereby the inlet valve 3 tends to move in the closing direction. Even if a failure occurs in the solenoid 9, the inlet valve 3 is biased by the spring member 11 through the armature 10 to be brought into the opened state as illustrated in FIG. 5A. Further, even if a failure occurs in the solenoid 9, the plunger 102 moves upward, and then the inlet valve 3 is pushed upward by the fuel compressed in the cylinder 101 to be brought into the closed state as illustrated in FIG. 5B.

This causes a so-called self-closing phenomenon. The inlet valve 3 is brought into the closed state, thereby pressure-feeding the fuel to the common rail 14. The state of the fuel injection will be described in more detail. The cam 103 starts rotating with the inlet valve 3 opening as illustrated in FIG. 6A. When the plunger 102 starts moving downward as illustrated in FIG. 6B, the fuel supplied from the feed pump 1 is introduced into the cylinder 101. Next, the plunger 102 starts moving upward to compress the fuel as illustrated in FIG. 6C. The inlet valve 3 is pushed and moved in the closing direction by a flow of the fuel is charged from the inlet hole 101a. The movement of the plate member 7 increases the preload of the spring member 12 biasing the inlet valve 3 in the closing direction. As a result, the biasing force of the spring member 12 and the flow force of the fuel compressed by the plunger 102 are larger than the biasing force of the spring member 12, whereby the inlet valve 3 is pushed upward to be brought into the closed state. As far as the plunger 102 continues compressing the fuel as illustrated in FIG. 6D, the inlet valve 3 can maintain the closed state, thereby the fuel compressed by the plunger 102 and retained in the cylinder 101 is fed to the common rail 14 side.

Thus, the adjustment device 20 according to the present embodiment can continue ejecting the fuel, when a failure occurs in the solenoid 9 for driving the inlet valve as an amount adjustment valve. The continuation of the fuel injection enables a vehicle to move to a safe place.

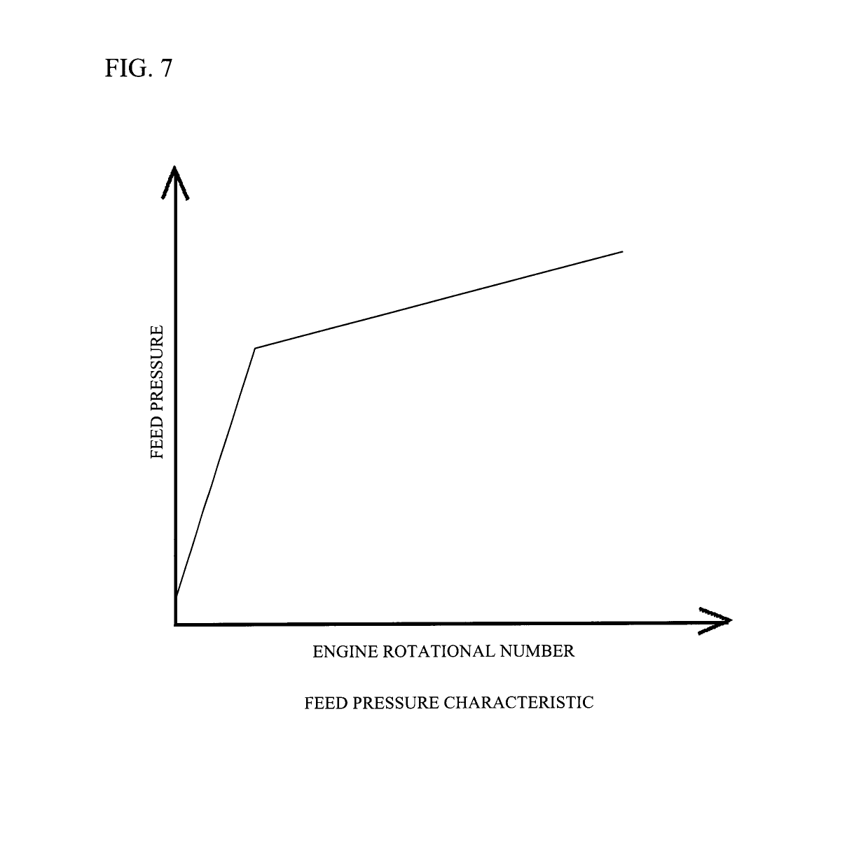

In the above embodiment, the ECU 13 detects a reduction in the rail pressure with the rail pressure sensor 14a, and controls the feed pump 1 to reduce the feed pressure. In other words, it is assumed that feed pump 1 is an electric type in the embodiment. However, even when a so-called mechanical feed pump may be used, the adjustment device 20 similar to the present embodiment may be employed. For example, when a failure occurs in the solenoid 9 like the above example, the pressure-feeding of the fuel to the common rail 14 is trouble to reduce the output of the engine. FIG. 7 is a graph illustrating a relationship between a feed pressure and an engine rotational number. A reduction in the output of the engine (engine rotational number) reduces the output of the feed pump driven by the rotation of a crank shaft or a camshaft. This reduces the feed pressure, thereby moving the plate member 7 as well as the above example.

This causes the self-closing phenomenon, thereby maintaining and continuing pressure-feeding the fuel. In a case where a mechanical feed pump is employed, the fuel pressure is controlled by a reducing valve installed in the common rail 14 so as to reduce the output of the engine, thereby positively causing the self-closing phenomenon.

While the exemplary embodiments of the present invention have been illustrated in detail, the present invention is not limited to the above-mentioned embodiments, and other embodiments, variations and modifications may be made without departing from the scope of the present invention. In the above embodiment, the high-pressure pump used for the diesel engine is assumed. However, the same adjustment device is applicable to a fuel pump used for a gasoline engine.

### DESCRIPTION OF LETTERS OR NUMERALS

1 feed pump
2 feed pump communication path
3 inlet valve
3b engagement flange portion
4 body portion
4a atmosphere releasing path
5 pipe-shaped portion
7 plate member (compression amount adjustment member)
7a first surface (feed pressure receiving surface)
7b second surface
7b 1 feed pressure receiving surface
7b2 atmospheric pressure receiving surface
9 solenoid
10 armature
11 spring member (biasing the inlet valve to the opening side)
12 spring member (biasing the inlet valve to the closing side)
13 ECU (Electronic control unit: control portion)
14 common rail
14a rail pressure sensor
20 adjustment device
100 high-pressure pump
101 cylinder
101a inlet hole
102 plunger

1. An adjustment device of a high-pressure pump for increasing a pressure of a fuel supplied from a feed pump and pressure-feeding the fuel, the adjustment device comprising:
an inlet valve changing a communication state between a cylinder provided in the high-pressure pump and a feed pump communication path through which the fuel supplied by the feed pump flows, and adjusting an injection amount of the high-pressure pump;
a spring member biasing the inlet valve to a closing side;
a closing portion, operated by energization, for allowing the inlet valve to move in a closing direction; and
a compression amount adjustment member changing a compression amount of the spring member depending on a feed pressure of the feed pump.

2. The adjustment device of the high-pressure pump of claim 1, wherein
the compression amount adjustment member is a plate member including a first surface and a second surface as a rear surface of the first surface,
the spring member is held between the first surface and an engagement flange portion provided in the inlet valve, and
a pressure receiving area of the feed pressure on the first surface is larger than that of the feed pressure on the second surface.

3. The adjustment device of the high-pressure pump of claim 1, further comprising:
a failure determination portion of the closing portion, in a case where the feed pump is electrically operated; and
a control portion reducing the feed pressure of the feed pump, when the failure determination portion determines that a failure occurs in the closing portion.

4. The adjustment device of the high-pressure pump of claim 3, wherein the failure determination portion determines that a failure occurs in the closing portion depending on a rail pressure of a common rail to which the fuel is supplied from the high-pressure pump.
